(19) United States
(12) Patent Application Publication
(10) Pub. No.: US 2009/0033491 A1
(43) Pub. Date: Feb. 5, 2009

(54) Method, System And Apparatus For Dwell Monitoring In A Retail Establishment

(76) Inventor: Rodney R. Saunders, Oak Island, NC (US)

Correspondence Address: GIBBONS P.C., ONE GATEWAY CENTER, NEWARK, NJ, 07102, US

(21) Appl. No.: 11/937,932

(22) Filed: Nov. 9, 2007

Related U.S. Application Data
(60) Provisional application No. 60/858,669, filed on Nov. 13, 2006.

(51) Int. Cl. G08B 13/14; G06Q 10/00

(52) U.S. Cl. 340/568.5; 705/1

(57) ABSTRACT

A method, system and apparatus for facilitating dwell monitoring in a retail store, including detecting and monitoring the number of shoppers in a store through the use of broadcasting devices, such as RFID tags, and associated signal detecting devices, and a processor for processing the information, and storage media for storing the information, as desired (such as, for example, a computer), and an event engine for comparing the information processed with threshold data to generate alerts when a threshold is reached.

### CROSS REFERENCE TO RELATED APPLICATIONS

This application claims priority to U.S. provisional application Ser. No. 60/858,669, filed on Nov. 13, 2006, the complete disclosure of which is incorporated herein by reference.

### BACKGROUND OF THE INVENTION

The present method, system and apparatus provides for monitoring and may be used to facilitate meeting needs for the checkout area, dynamically maintain appropriate staffing levels, create “surge” models, analyze periodic trends and improve customer service. The method, system and apparatus may be used to manage aspects of a retail store facility.

### BRIEF SUMMARY OF THE INVENTION

An embodiment provides a method, system and apparatus for facilitating dwell monitoring. The number of shoppers in a store may be detected through the use of broadcasting devices, such as RFID tags, and associated signal detecting devices. The information may be stored and processed with storage equipment and a processor (such as, for example, a computer).

### BRIEF DESCRIPTION OF THE DRAWINGS

FIG. 1 is a schematic illustration showing the monitoring of a retail area.

FIG. 2 is a schematic diagram illustrating a method, system and apparatus for monitoring in a retail store.

### DETAILED DESCRIPTION OF THE INVENTION

One embodiment of the method, system and apparatus utilizes WiFi enabled RFID tags to determine the number of shoppers in the checkout area (or any other area) of the store. The RFID tags are associated with a cart, basket or carrier which a consumer utilizes while in the retail establishment. Detection apparatus is positioned in one or more locations throughout the retail establishment to receive transmissions from RFID devices. The transmissions are processed with a processing device, such as a computer, and may be stored. Software may be used to provide a set of instructions for handling the information received from the RFID tags. For example, information may include at which location the RFID detection apparatus may be based on the detection apparatus location which senses the RFID in its vicinity. Detection apparatus may be associated with one or more zones within the establishment. For example, a single detector or group of detectors may define a zone, the zone being within the range of the single detector, or group of detectors. Alternately, or in addition thereto, different detectors (or different groups of detectors) may define different zones. The detection apparatus may receive transmissions from cart associated RFID tags, to determine the number of carts, or individuals, in a particular zone of the establishment.

This will allow retailers to dynamically maintain staffing, create ‘surge’ models, periodic trends and provide better customer service. For example, if the dwell time for moveable carts in the checkout area (a zone) reaches a certain threshold, then this information may be used to generate an alert, such as for example, that more cashiers are needed at the checkout (i.e., more lanes need to be opened).

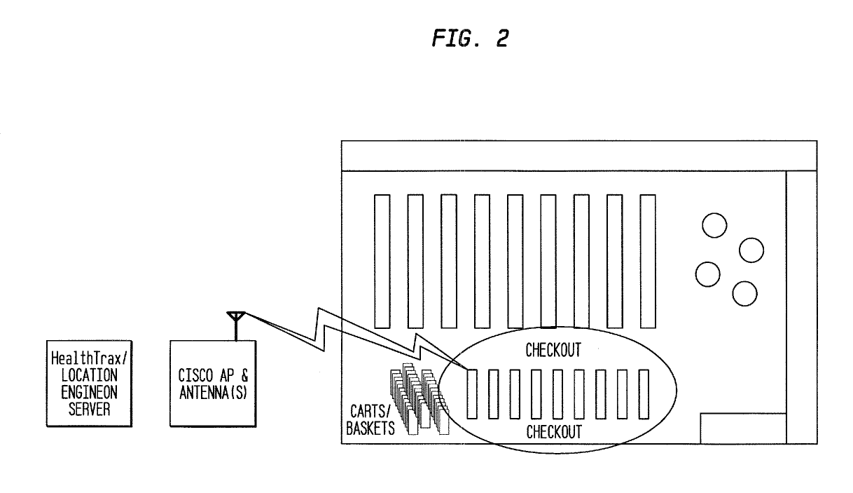

An example illustrating an embodiment of the invention is shown in FIG. 2. FIG. 2 is a schematic diagram illustrating a method, system and apparatus for monitoring a checkout area and alerting management when the number and dwell time of customers in a checkout zone exceeds a threshold. Software is employed on a processing device, such as for example, a computer to utilize data from a location engine source (which may be a commercially available software package) to monitor ‘dwell time’ and create events based on variable thresholds. For example, the dwell time may be the time which a consumer is present in the checkout zone. The event engine, which for example, may comprise software containing a set of instructions which may be executed when a threshold number of RFID devices (e.g., carts or consumers) are present at the checkout, or when dwell time for one or more associated RFID tags is sensed at the checkout zone. The event engine may then utilize one or multiple communication paths for alerting people, such as store management or employees, or other systems, and may record data for further analysis.

An embodiment uses one or more antenna to regulate the dimension of the zone of coverage for the detector (or group of detectors). For example, a tunable antenna may be employed to provide a geometrically configurable zone. For example, where a checkout zone is a generally linear zone of adjacent stations, the detector may be configured to cover the adjacent checkout stations. One embodiment uses a unidirectional antenna. The antenna may have or be configured with a unidirectional radiation and response pattern, such as, for example a Yagi antenna.

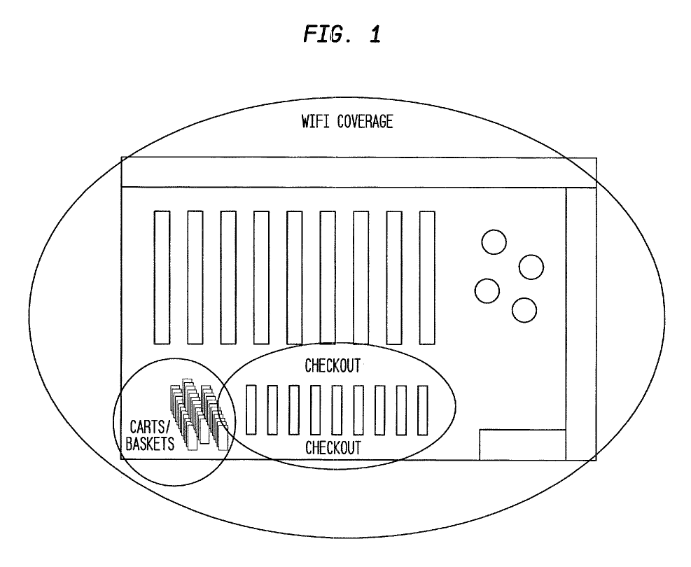

FIG. 1 illustrates another embodiment where multiple data, which includes dwell time data and demand data, is utilized. The system, method and apparatus illustrated in the schematic view of FIG. 1, shows the monitoring of an entire retail area (which may comprise one zone or multiple zones) and creating ‘demand’ and ‘dwell time’ data based on the ratio(s) of shoppers in the store versus those preparing to check out. For example, the RFID tags may indicate through detection by one or more detection apparatus the number of carts, baskets or other containers (which correspond with the number of shoppers in the store) on one hand, and the number of carts, baskets or other containers (which correspond with the number of shoppers in the store) on the other hand which are at the checkout zone.

The method, system and apparatus include configuring areas of the store to correspond with one or more zones. For example the zones may include one or more checkout zones, and may additionally or alternately include plurality of zones throughout the store. For example, a zone may be configured to receive RFID transmissions within an area of a marketing display. The display zone may sense the presence of RFID tags, their duration within the zone or dwell time, and record and/or report this data. For example, one marketing display may have results (e.g., dwell time and visit frequency) greater than another marketing display. The sensed data may provide this information, and the information used to facilitate purchases through efficient use of displays. The retailer may use the system, method and apparatus to determine how long shoppers ‘stayed’ in a certain department or in front of a marketing display, a practice which generally is sometimes referred to as ‘stickiness’ in marketing parlance. Benefits may be derived by not only in retail store operations by retailers, but also by CPG companies who are continuously trying to determine the most valuable marketing displays and shelf facing tactics.

What is claimed is:

1. A method for facilitating monitoring of shoppers in a store, including:
placing one or more signal detecting devices in a location within a store, said range of said signal detecting device comprising a zone;
associating with a movable can an RFID tag;
sensing the RFID tag as the movable cart is moved within the range of a signal detecting device;
collecting the information to determine the number of RFID devices in a particular zone;
determining whether the number of RFID devices detected within said particular zone meets a threshold;
generating an alert when the number of RFID devices meets a threshold.

2. The method of claim 1, wherein the zone is a location at the checkout location of the store.

3. The method of claim 1, wherein the dwell time for RFID devices corresponding to moveable carts in the checkout location is determined, and wherein the alert is generated when the RFID devices associated with said moveable carts dwell in said checkout location for a predetermined length of time.

4. A system for facilitating monitoring of shoppers in a store, including:
at least one signal detecting device adapted for positioning in a location within a store, said signal detecting device having a range corresponding to a zone;
an RFID tag adapted to be carried on a movable cart;
wherein said RFID tag carried by said movable cart is configured to be detectible when said RFID tag is said zone corresponding to said signal detecting device;
data collection means for collecting the information to determine the number of RFID devices in a particular zone;
means for determining whether the number of RFID devices detected within said particular zone meets a threshold;
alert generating means for generating an alert when the number of RFID devices in said zone meets a threshold.

5. The system of claim 4, wherein a plurality of signal detecting devices are provided, and wherein a plurality of zones are configured, wherein each zone corresponds with one signal detecting device or a group of signal detecting devices.

6. An apparatus for managing retail store facilities, including
at least one signal detecting device adapted for positioning in a location within a store, said signal detecting device having a range corresponding to a zone;
an RFID tag adapted to be carried on a movable cart;
wherein said RFID tag carried by said movable cart is configured to be detectible when said RFID tag is said zone corresponding to said signal detecting device;
a device for collecting data from said signal detecting device for collecting the information to determine the number of RFID devices in a particular zone;
an event engine for determining whether the number of RFID devices detected within said particular zone meets a threshold, said event engine being configured to generate an alert to correspond with detection criteria.
